(19) United States
(12) Patent Application Publication
(10) Pub. No.: US 2014/0115070 A1
(43) Pub. Date: Apr. 24, 2014

(54) APPARATUS AND ASSOCIATED METHODS

(71) Applicant: NOKIA CORPORATION, Espoo (FI)

(72) Inventors: Otso Virtanen, Helsinki (FI); Mohammad Dhani Anwari, Helsinki (FI); Michael Hasselmann, Panketal (DE)

(73) Assignee: NOKIA CORPORATION, Espoo (FI)

(21) Appl. No.: 13/657,293

(22) Filed: Oct. 22, 2012

(51) Int. Cl. G06F 15/16

(52) U.S. Cl. 709/206

(57) ABSTRACT

An apparatus comprising at least one processor; and at least one memory including computer program code, the at least one memory and the computer program code configured to, with the at least one processor, cause the apparatus to perform at least the following: during message composition using a keyboard, use one or more of the keyboard entered characters forming part of the message to search for one or more content items having metadata matching the one or more entered characters; and provide the one or more content items having matching metadata for insertion or attachment to the message.

### TECHNICAL FIELD

The present disclosure relates to the field of user interfaces, associated methods, computer programs and apparatus. Certain disclosed aspects/examples relate to portable electronic devices, in particular, hand-portable electronic devices, which may be hand-held in use (although they may be placed in a cradle in use). Such hand-portable electronic devices include Personal Digital Assistants (PDAs), mobile telephones, smartphones and other smart devices, and tablet PCs.

Portable electronic devices/apparatus according to one or more disclosed aspects/examples may provide one or more: audio/text/video communication functions such as tele-communication, video-communication, and/or text transmission (Short Message Service (SMS)/Multimedia Message Service (MMS)/emailing functions); interactive/non-interactive viewing functions (such as web-browsing, navigation, TV/program viewing functions); music recording/playing functions such as MP3 or other format, FM/AM radio broadcast recording/playing; downloading/sending of data functions; image capture functions (for example, using a digital camera); and gaming functions.

### BACKGROUND

Electronic devices can allow users to input messages and text. A user may insert or attach a file to such a message or text document. A user may attach a file to an e-mail message, for example by selecting an “attachment” option and choosing a file to attach from a menu system. As another example, a user may insert an image in an MMS message using a portable electronic device by selecting an “insert media” option, and selecting an image, audio or video file to be inserted in the multimedia message. A user may have many hundreds of possible files which may be attached to a message or text document.

The listing or discussion of a prior-published document or any background in this specification should not necessarily be taken as an acknowledgement that the document or background is part of the state of the art or is common general knowledge. One or more aspects/examples of the present disclosure may or may not address one or more of the background issues.

### SUMMARY

In a first aspect there is provided an apparatus comprising at least one processor; and at least one memory including computer program code, the at least one memory and the computer program code configured to, with the at least one processor, cause the apparatus to perform at least the following: during message composition using a keyboard, use one or more of the keyboard entered characters forming part of the message to search for one or more content items having metadata matching the one or more entered characters; and provide the one or more content items having matching metadata for insertion or attachment to the message.

The apparatus allows an item of content (e.g., a multimedia content item) to be provided for inclusion with/attachment to the message based on the text input during message composition. In certain embodiments, a single item, or a group of items (e.g., small enough to be presented to the user without obscuring the message being composed), may be accessed so that the user can select a content item to include with the message, without being required to navigate any additional menus, or selecting an “attach”, “insert”, or other extra button.

The content items provided (e.g., presented) to the user may be a relatively small group, as they are a sub-set selected for presentation based on them having metadata in common with a group of one or more characters in the message. Thus, a user may enter the word “holiday” in a message, and be presented with a series of photographs and movies with the metadata “holiday”, so that one or more holiday photographs/movies may be selected for inclusion with the message being composed. Non-relevant content, i.e., content not relating to “holiday” would not be provided/presented. Thus, after selection for insertion/attachment, the user can, in certain embodiments, continue composing their message with little distraction due to attaching a file.

In certain examples, the message being composed may remain displayed through the message composition and item attachment, allowing the user to remain focussed on composing the message without getting “sidetracked” in locating a relevant multimedia item to attach to the message.

The keyboard may be a virtual keyboard or a physical keyboard. Content may be added to a text-based message directly from the virtual or physical keyboard, greatly reducing any need to open and use menus or other file systems to specifically and separately find the desired content for inclusion with the message.

In the case of a virtual keyboard, in certain examples, it may be possible to view a series of content items for inclusion with the message while the message and the virtual keyboard remain at least partially displayed. This may allow the user to continue composing the message after content item inclusion with little distraction due to, for example, the virtual keyboard being completely removed from display for content item selection and being re-displayed after content item inclusion.

The message may be a multimedia service message, an e-mail message, an electronic note, an electronic diary entry, a social media message, a website posting, a Facebook message, a Twitter message, or other message composed in a messaging application.

The keyboard entered characters may represent a complete or partial entry of a word or expression. The keyboard entered characters may be a single character. This may be particularly advantageous for example, when the total number of content items to choose from is relatively small, such that the entry of a single initial letter is enough to reduce the number of content items having metadata with a matching initial to a manageable number for display and selection.

The apparatus may be configured to perform the search progressively as each character of a full word or full expression is progressively entered. Thus the number of content items found to have metadata matching the word being entered is likely to reduce as more characters of a word are entered. This allows the user to enter just enough characters to enable a manageably small group of content items having metadata matching the partially entered word to be displayed for selection. The remainder of the word may be auto-completed in some examples, for example using predictive text functionality. The search could be done before or after the text auto-complete action.

The apparatus may be configured to perform the search upon the completion of entry of a full word or full expression. The completion of a full word or full expression may be indicated by entry of a character space, by a pause between key presses of a predetermined length, or by a specific key indication (such as a full stop entry or search key/icon selection), for example. The recognition of a word entry being completed may be a prompt for the apparatus to search for one or more content items having metadata matching the entered word.

The apparatus may be configured to perform the search using a combination of two or more full words (e.g., including names, proper nouns, or proper nouns with a joining word) or full expressions which are entered. For example, the apparatus may perform the search after a pause of a predetermined length (or in some cases after the entry of a “search” input (pressing a “search” key or selecting a “search” icon)) based on a message containing two or more words or expressions. Thus a user may enter the text “Holiday with Jeff”, and then indicate a search is required by waiting for a pause of, for example, three seconds. Any content items having metadata matching both “holiday” and “Jeff” may be provided for attachment to/inclusion with the message. The word “with” is considered as a joining word in this example. The use of “holiday” with a joining word and a proper noun (“Jeff”) may, in certain embodiments be detected by the apparatus, and the detection may automatically start the search. After the search, content items matching the metadata “holiday” and “Jeff” may be displayed for the user to look through and select for inclusion in the message.

In another example, the use of a joining word would not necessarily be required in searching for relevant content. Thus, the use of “holiday” and “Jeff”, per se, when composing a message, would cause the apparatus to search for content items having metadata of both “holiday” and “Jeff”. Therefore use of a combination of two or more full words would provide context based searching.

The apparatus may be configured such that the one or more entered characters forming part of the message are retained in the composed message. The apparatus may be configured such that the one or more entered characters forming part of the message are replaced with the one or more content items having matching metadata in the composed message.

The apparatus may be configured such that the one or more content items having matching metadata are inserted adjacent the one or more entered characters used to search.

The apparatus may be configured such that the one or more entered characters forming part of the message are replaced with the one or more content items having matching metadata in the composed message. Therefore a user may enter the text “Congr . . . ”, the apparatus may identify and provide content items having the metadata “congratulations!” including, for example, an animation of a champagne bottle being opened with a congratulations banner. This animation may be selected by the user and will replace the text “Congr . . . ” in the message.

The apparatus may be configured such that the one or more entered characters forming part of the message are searched against a categorisation aspect of the metadata. One or more content items having a matching categorisation, as indicated by the entered characters, may be provided for insertion or attachment to the message. The categorisation may be one or more of Image, Video, Music, Contact, Document and Other (e.g., a general) categorisation of content items. Thus a user may enter the term “Document”, and be presented with a list of documents (content items having the metadata “Documents”) for attachment at the exclusion of content items which are not labelled with a “Document” metadata label. For example, photographs and movies may not be labelled as “Documents” and therefore would not be identified positively by the search. Not all content need be specifically categorised, but it will be appreciated that the absence of a specific categorisation may be a categorisation in itself (i.e. a “No category” categorisation).

The metadata of a content item may comprise: a user-assigned label for the content item; an automatically-assigned label for the content item; an auto-recognition text label for the content item; at least part of a file name of the content item; a storage location of the content item; or text within the content item.

The apparatus may be configured to perform the search upon a specific user search indication associated with at least one of:
a single key of the keyboard used to enter a character completing a part of the message;
a displayed symbol indicating an identified match between part of the composed message and matching metadata; and
a display of the entered characters forming a part of the message.

A specific user search indication may comprise:
a long key press of a physical key in entering a character of a partial or complete word or expression
a long key press over an initial letter of a partial or complete, word or expression
a particular user gesture over an initial (and/or end) letter/character of a partial or complete word or expression
user key input entry of a code corresponding to a category of content item (e.g. a user may enter the code “V”, “V_”, “_V” or “_V_” where “_” indicates a space, to search for video content, or the code “I” or “_I_” for image content)
a user input corresponding to an indicator, the indicator being displayed due to the partial or complete user entry of a metadata label.

A user gesture may be, for example: a zigzag gesture; a flick; a double tap; a stroke down or in any other direction; a circle around a particular character, partial or complete word or expression; or any other user gesture which may be set to correspond to a selection of a partial or complete word or expression as metadata to perform a corresponding content item search.

The apparatus may be configured such that the keyboard entered characters forming part of the message are shown as characters on a display.

The keyboard may be a virtual keyboard and the apparatus may be configured such that the keyboard entered characters forming part of the message are shown as characters on a display at the same time as display of the virtual keyboard.

The apparatus may be configured such that the keyboard entered characters are shown as characters in a message output part of the display, and the virtual keyboard is shown in a message input part of the same display.

The apparatus may be configured to provide a plurality of content items having matching metadata for user selection in a pick-list prior to insertion or attachment of a content item to the composed message. The pick-list may contain a plurality of selectable words, phrases, and/or content items for insertion. For example, a list of predictive-text matches may be provided alongside one or more content items found to have metadata matching the text. A user may enter the text “Foot”, for example, and the apparatus may provide a pick-list containing a list of the words “foot”, “football” and “footman”, as well as photographs which have the metadata label “football”, such as photographs of the user playing in a football match. In other examples, the pick-list may contain content items for insertion or attachment but may not contain any words or phrases for auto-completion of a word or phrase. In this example any predictive text functionality may be presented separately from any pick-list of content items found to have metadata matching text in the message being composed.

The keyboard may be a virtual keyboard, and the apparatus may be configured to retain the virtual keyboard on screen (in the foreground or background) during the searching of metadata and/or during the entry of the one or more matching content items into the composed message.

The apparatus may be a portable electronic device, a mobile telephone; a smartphone, a personal digital assistant, a tablet computer, a messenger device, a non-portable electronic device, a desktop computer, or a module for the same.

The message may be for wired or wireless transmission to a device which is independently operable to the apparatus.

In a further aspect there is provided a computer program code configured to:
during message composition using a keyboard, use one or more of the keyboard entered characters forming part of the message to search for one or more content items having metadata matching the one or more entered characters; and
provide the one or more content items having matching metadata for insertion or attachment to the message.

In a further aspect there is provided a computer readable medium comprising computer program code stored thereon, the computer readable medium and computer program code being configured to, when run on at least one processor, perform at least the following:
during message composition using a keyboard, use one or more of the keyboard entered characters forming part of the message to search for one or more content items having metadata matching the one or more entered characters; and
provide the one or more content items having matching metadata for insertion or attachment to the message.

In a further aspect there is provided a method, the method comprising:
during message composition using a keyboard, using one or more of the keyboard entered characters forming part of the message to search for one or more content items having metadata matching the one or more entered characters; and
providing the one or more content items having matching metadata for insertion or attachment to the message.

In a further aspect there is provided an apparatus, the apparatus comprising:
means for using, during message composition using a keyboard, one or more of the keyboard entered characters forming part of the message to search for one or more content items having metadata matching the one or more entered characters; and
means for providing the one or more content items having matching metadata for insertion or attachment to the message.

The present disclosure includes one or more corresponding aspects, examples or features in isolation or in various combinations whether or not specifically stated (including claimed) in that combination or in isolation. Corresponding means and corresponding functional units (e.g., physical or virtual keyboard, content item searcher, metadata identifier, content item provider, content item inserter, content item attacher) for performing one or more of the discussed functions are also within the present disclosure.

Corresponding computer programs for implementing one or more of the methods disclosed are also within the present disclosure and encompassed by one or more of the described examples.

The above summary is intended to be merely exemplary and non-limiting.

### BRIEF DESCRIPTION OF THE FIGURES

A description is now given, by way of example only, with reference to the accompanying drawings, in which:

FIG. 1 illustrates an example apparatus according to the present disclosure;

FIG. 2 illustrates another example apparatus according to the present disclosure;

FIG. 3 illustrates another example apparatus according to the present disclosure;

FIG. 4 illustrates a metadata database listing available content items and associated metadata;

FIGS. 5a-5d illustrate selection and insertion in a message of a content item;

FIGS. 6a-6d illustrate selection and insertion in a message of a content item;

FIGS. 7a-7f illustrate selection and insertion in a message of a content item;

FIGS. 8a-8b illustrate selection of a content item and attachment of it to a message;

FIGS. 9a-9d illustrate specific user search interactions;

FIGS. 10a-10b illustrate the apparatus in communication with a remote server or cloud;

FIG. 11 illustrates a method according to the present disclosure; and

FIG. 12 illustrates a computer readable medium comprising computer program code according to the present disclosure.

### DESCRIPTION OF EXAMPLE ASPECTS

Electronic devices can allow users to input messages and text. When writing e-mails or other rich media documents, often a user may wish to insert or attach a file to such an e-mail message or document. For example, a user may wish to attach a file to an e-mail message, and may do this by selecting an “attachment” option and choosing a file to attach from a file menu system. As another example, a user may insert an image in an MMS message using a portable electronic device by selecting an “insert media” option, and selecting an image, audio or video file to be inserted in the multimedia message from a media library. Other examples are of a user, who may wish to include a photograph in the body of an e-mail, or attach a video to an MMS message. The decision to include the multimedia content may occur part way through writing the text document (for example, because the content is to be inserted at that place in the document).

The message could be a message which is not necessarily for transmission to a remote device/apparatus. For example, the message could be an electronic note which is retained on the device/apparatus for later viewing.

A user may have to break the flow of the text input and enter an “attachment” menu, file browser, gallery application, or similar in order to select an item for entry into/attachment with the message or document being composed. It may require several key presses and/or navigation of one or more menus or screens before the user is able to select the required item to be included with the message. This navigation process can be distracting and cumbersome. This may be particularly true for a user using a device with a smaller screen such as a smartphone or mobile telephone. The user interface used to allow a user to select an item for insertion/attachment is likely to completely obscure the text input user interface, thereby exaggerating the break in the text input.

A user may have many hundreds of possible files which may be attached to a message or text document. A user may be required to navigate a large media collection in order to find the item of interest. If the user cannot remember where the item has been saved then it can be difficult and time consuming to find the item of interest for inclusion with the message being composed. This can take time and the user may lose their “train of thought” for composing the message.

It is an object of one or more examples disclosed herein to allow a user to insert/attach multimedia content into/to a text document more quickly/intuitively/efficiently and in a more integrated way with the text input. It is also an object of one or more examples to allow a user to attach and/or include content in a message, while reducing any menu navigation necessary to specifically find the item(s) of interest from a potentially large full list of content items. It is also an object of one or more examples to allow the user to select an item for inclusion or attachment to a message from a tailored pick-list of relevant content items, thereby allowing the user to find the content item of interest more quickly and easily. Further, it is an object of one or more examples to allow the user to compose their message, with attachments/inserted content, with reduced interruptions, thereby allowing for a more intuitive and easier user interface experience.

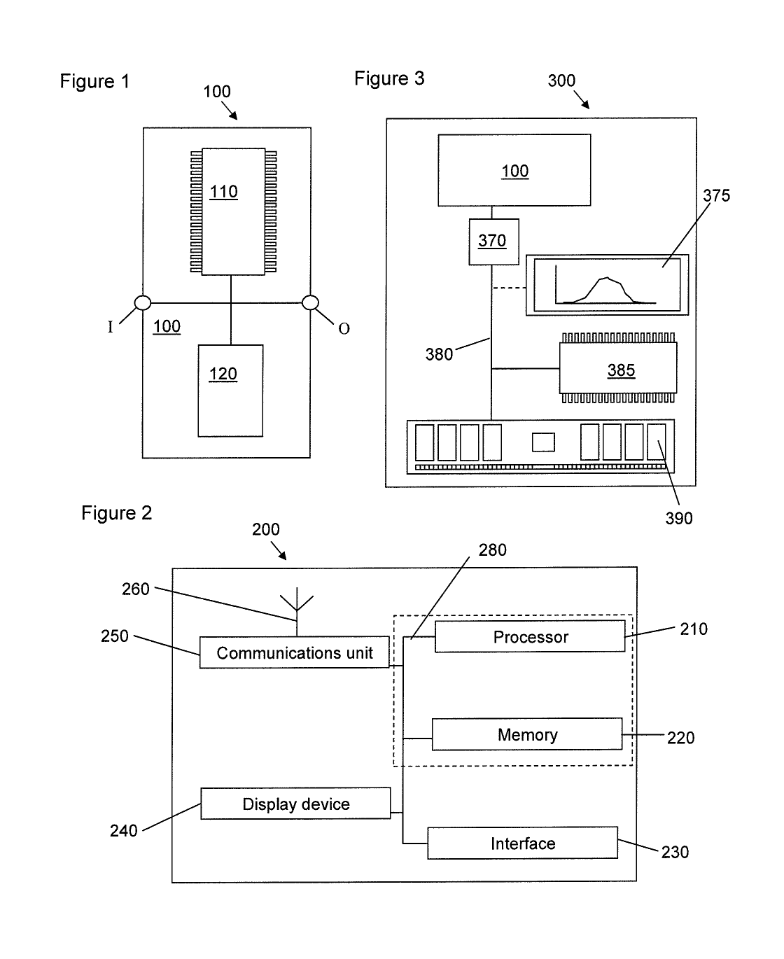

Examples disclosed herein relate to message composition using an electronic device. FIG. 1 shows an apparatus 100 comprising a processor 110, memory 120, input I and output O. In this example only one processor and one memory are shown but it will be appreciated that other examples may use more than one processor and/or more than one memory (for example, the same or different processor/memory types). The apparatus 100 may be an application specific integrated circuit (ASIC) for a portable electronic device. The apparatus 100 may also be a module for a device, or may be the device itself, wherein the processor 110 is a general purpose CPU and the memory 120 is general purpose memory.

The input I allows for receipt of signalling (for example, by hard-wiring or Bluetooth or over a WLAN) to the apparatus 100 from further components. The output O allows for onward provision of signalling from the apparatus 100 to further components. In this example the input I and output O are part of a connection bus that allows for connection of the apparatus 100 to further components. The processor 110 is a general purpose processor dedicated to executing/processing information received via the input I in accordance with instructions stored in the form of computer program code on the memory 120. The output signalling generated by such operations from the processor 110 is provided onwards to further components via the output O.

The memory 120 (not necessarily a single memory unit) is a computer readable medium (such as solid state memory, a hard drive, ROM, RAM, Flash or other memory) that stores computer program code. This computer program code stores instructions that are executable by the processor 110, when the program code is run on the processor 110. The internal connections between the memory 120 and the processor 110 can be understood to provide active coupling between the processor 110 and the memory 120 to allow the processor 110 to access the computer program code stored on the memory 120.

In this example the input I, output O, processor 110 and memory 120 are electrically connected internally to allow for communication between the respective components I, O, 110, 120, which in this example are located proximate to one another as an ASIC. In this way the components I, O, 110, 120 may be integrated in a single chip/circuit for installation in an electronic device. In other examples one or more or all of the components may be located separately (for example, throughout a portable electronic device such as devices 200, 300, or through a “cloud”, and/or may provide/support other functionality.

One or more examples of the apparatus 100 can be used as a component for another apparatus as in FIG. 2, which shows a variation of apparatus 100 incorporating the functionality of apparatus 100 over separate components. In other examples the device 200 may comprise apparatus 100 as a module (shown by the optional dashed line box) for a mobile phone, PDA or audio/video player or the like. Such a module, apparatus or device may just comprise a suitably configured memory and processor.

The example apparatus/device 200 comprises a display 240 such as a Liquid Crystal Display (LCD), e-Ink, or (capacitive) touch-screen user interface. The device 200 is configured such that it may receive, include, and/or otherwise access data. For example, device 200 comprises a communications unit 250 (such as a receiver, transmitter, and/or transceiver), in communication with an antenna 260 for connection to a wireless network and/or a port (not shown). Device 200 comprises a memory 220 for storing data, which may be received via antenna 260 or user interface 230. The processor 210 may receive data from the user interface 230, from the memory 220, or from the communication unit 250. The user interface 230 may comprise one or more input units, such as, for example, a physical and/or virtual button, a touch-sensitive panel, a capacitive touch-sensitive panel, and/or one or more sensors such as infra-red sensors or surface acoustic wave sensors. Data may be output to a user of device 200 via the display device 240, and/or any other output devices provided with apparatus. The processor 210 may also store the data for later user in the memory 220. The device contains components connected via communications bus 280.

The communications unit 250 can be, for example, a receiver, transmitter, and/or transceiver, that is in communication with an antenna 260 for connecting to a wireless network (for example, to transmit a determined geographical location) and/or a port (not shown) for accepting a physical connection to a network, such that data may be received (for example, from a white space access server) via one or more types of network. The communications (or data) bus 280 may provide active coupling between the processor 210 and the memory (or storage medium) 220 to allow the processor 210 to access the computer program code stored on the memory 220.

The memory 220 comprises computer program code in the same way as the memory 120 of apparatus 100, but may also comprise other data. The processor 210 may receive data from the user interface 230, from the memory 220, or from the communication unit 250. Regardless of the origin of the data, these data may be outputted to a user of device 200 via the display device 240, and/or any other output devices provided with apparatus. The processor 210 may also store the data for later user in the memory 220.

Device/apparatus 300 may be an electronic device, a portable electronic device, a portable telecommunications device, or a module for such a device (such as a mobile telephone, smartphone, PDA or tablet computer). The apparatus 100 can be provided as a module for a device 300, or even as a processor/memory for the device 300 or a processor/memory for a module for such a device 300. The device 300 comprises a processor 385 and a storage medium 390, which are electrically connected by a data bus 380. This data bus 380 can provide an active coupling between the processor 385 and the storage medium 390 to allow the processor 385 to access the computer program code.

The apparatus 100 in FIG. 3 is electrically connected to an input/output interface 370 that receives the output from the apparatus 100 and transmits this to the device 300 via a data bus 380. The interface 370 can be connected via the data bus 380 to a display 375 (touch-sensitive or otherwise) that provides information from the apparatus 100 to a user. Display 375 can be part of the device 300 or can be separate. The device 300 also comprises a processor 385 that is configured for general control of the apparatus 100 as well as the device 300 by providing signalling to, and receiving signalling from, other device components to manage their operation.

The storage medium 390 is configured to store computer code configured to perform, control or enable the operation of the apparatus 100. The storage medium 390 may be configured to store settings for the other device components. The processor 385 may access the storage medium 390 to retrieve the component settings in order to manage the operation of the other device components. The storage medium 390 may be a temporary storage medium such as a volatile random access memory. The storage medium 390 may also be a permanent storage medium such as a hard disk drive, a flash memory, or a non-volatile random access memory. The storage medium 390 could be composed of different combinations of the same or different memory types.

According to examples disclosed herein, an apparatus/device is able to access stored content items which are available for inclusion (attachment to, or insertion in) a message. Such content items may be stored on a memory of the apparatus/device, or may be stored remotely, for example on a server or cloud which the apparatus/device can access. At least one of these content items has at least one metadata label/tag associated with it.

A content item could be any multimedia file, such as a photograph, other image, movie, animation or sound/audio file. Content items may be items which may be attached to or inserted into messages, such as contacts (for example, an electronic business card for a contact in an address book may be attached to an e-mail), and documents (attaching or inserting a word processing document, spreadsheet, database extract, presentation slide(s), or pdf file to a document). A metadata tag, or tags, may be associated with any content item, such as a photograph, document, spreadsheet, movie, or electronic business card.

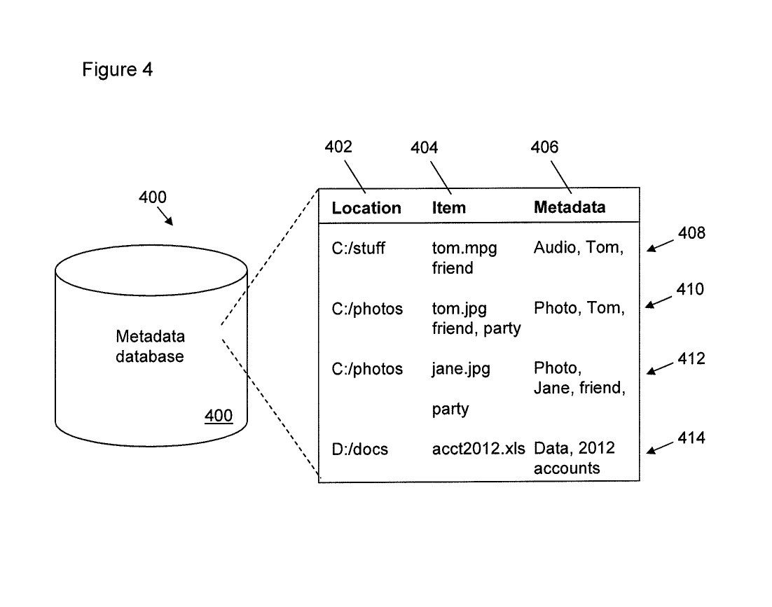

FIG. 4 illustrates an example database of metadata for a series of content items. Metadata for available content items may be stored in a database or similar suitable storage. The database in this example stores the storage location of the content item 402, the filename of the content item 404, and the metadata associated with that content item 406. In other examples other information may be stored, such as the last date of access, for example.

One content item shown in row 408 is listed as being stored in “C:/stuff”, and is a sound file called “tom.mpg”. The metadata associated with this content item is shown as “Audio, Tom, friend”. This file may be a sound recording of a user's friend, Tom, singing in a competition. Another content item in row 410 is stored in “C:/photos”, and is an image file called “tom.jpg”. This file has associated metadata of “Photo, Tom, friend, party”. Another content item in row 412 is also stored in “C:/photos”, and is an image file called “jane.jpg”. This file has associated metadata of “Photo, Jane, friend, party”. These two files may be photographs of a user's friends, Tom and Jane, at a party. A further content item in row 414 is stored in “D:/docs”, and is an image file called “acct2012.xls”. This has associated metadata of “Data, 2012, accounts”, and may be a spreadsheet file listing the user's accounts for the year 2012. Such a database may store metadata for many hundreds of available content items.

A metadata label may be related to the type of content, such as for example, Image, Photo, Video, Music, Audio, Contact, Data, Document and Other. The “Other” category may be a category (e.g., automatically or manually) assigned to any content item which does not fall in any of the other named categories. A content item may have associated metadata which relates to the particular content, for example, the names of people in the photograph (Tom and Jane), the name of the folder storing the photograph in a file system (“stuff”, “photos”, “docs”), the name of the person who took the photograph, or the date/month/year when a content item was created/modified/stored.

Metadata labels may be:
automatically assigned to the content item (for example, a metadata label “Camera” may automatically be linked to all photographs and movies recorded using a camera of a device)
user-assigned to the content item (for example, by a user adding metadata labels of the names of the people in the photographs (Tom, Jane), or by a particular date, event name (“Party, “Holiday”, “Birthday”), or other identifying characteristic)
assigned by auto-recognition (for example, face recognition software may be used to automatically add a metadata label of a person's name to a photograph which they are recognised as being in)
part or all of a filename on a content item (for example, a file called “school_register.xls” may have associated metadata labels of “school” and “register”)
text within a content item (for example, a contact list entry containing the text “Lisa Jones” and “colleague” may have associated metadata labels of “Lisa”, “Jones” and “colleague”).

An example apparatus may be configured such that one or more entered characters forming part of the message are searched against a categorisation aspect of the metadata. Thus, a person may type the e-mail message “Have you seen a photo of Amy's new haircut” and the word “photo” may be searched against a categorisation of Photograph content items (that is, content items having the metadata “Photograph”). The word “Amy” may also be searched to find content items with the metadata “Amy”. One or more content items having a matching “Photo” categorisation, as indicated by the entered characters, may be provided for insertion or attachment to the message.

Thus the user may be presented with a pick-list of photographs for attachment to the message, so that he can send his friend an email including “Have you seen a photo of Amy's new haircut” with a relevant photograph attached. The user does not have to search through all files available for attachment because, due to the metadata matching of the entered word “Photo” and all content items having the metadata “Photo”, only content items having the “Photo” metadata label will be presented for attachment. If the word “Amy” is also used to find content with matching metadata, the content items found to match the entered characters of the message would be more specifically selected than items with the “Photo” metadata, and would be content items which are “Photo” content items relating to “Amy”.

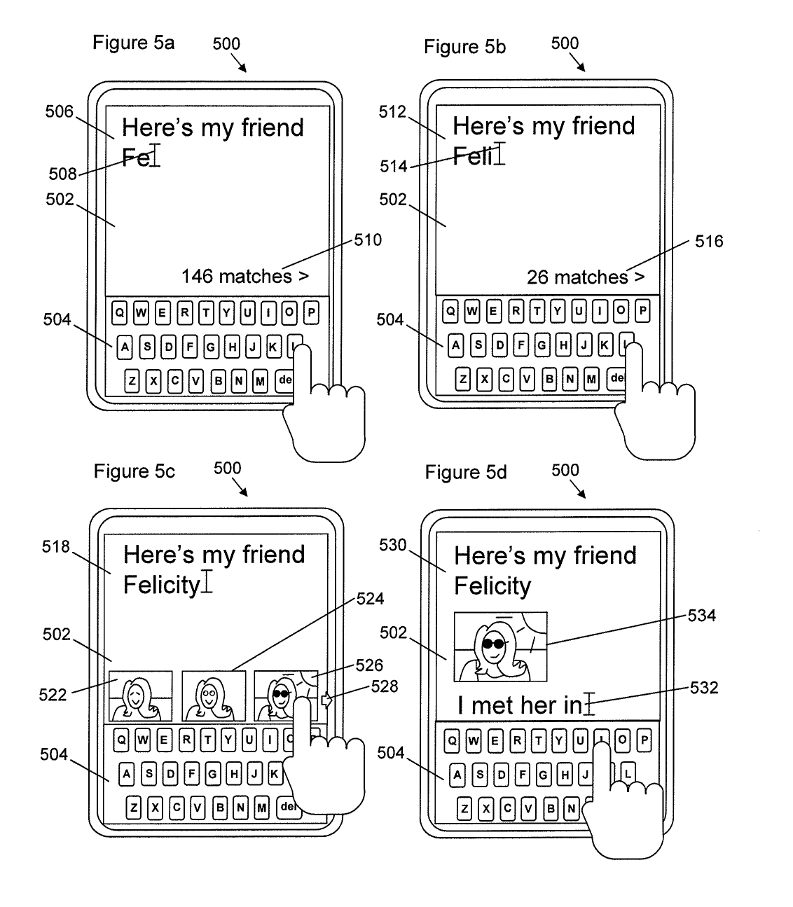

FIGS. 5a-5d illustrate an example of the apparatus/device 500 in use. A user is composing an MMS message using a smartphone 500. The display of the smartphone in this example is touch-sensitive and is displaying a message area 502 and a virtual keyboard 504 (although in other embodiments it could be a physical keyboard). In this example, the apparatus is configured such that the keyboard entered characters are shown as characters in a message output part of the display 502, and the virtual keyboard is shown in a message input part 504 of the same display. The user in this example is composing a message to a friend about their new friend Felicity.

In FIG. 5a, the user has partially entered the message 506 so that it reads “Here's my friend Fe . . . ”. The word “Felicity” has only partially been entered and the text carat 508 is shown at the current end of the message 506. The apparatus is configured to use the keyboard entered characters forming part of the message 506, in this case “Fe . . . ”, to search for one or more content items having metadata matching the entered characters.

The apparatus has identified 146 matching content items for the metadata “Fe”. This may include, for example, any content item having a metadata label which begins with, or contains, the character string “Fe”. The metadata matching may be case sensitive. In this example, the user is able to select the “146 matches” display 510, for example by touching it on the display. If he did this, a list of the 146 possible matching items would be displayed for the user to select a content item of interest. The apparatus thus provides one or more content items having matching metadata for insertion or attachment to the message. The user can make one selection to open the list of 146 items (and a further selection to choose an item of interest for inclusion with the message) or just continue typing.

The user in this example has many photographs, videos, audio files, content entries and documents which have associated metadata beginning with or including “Fe”: for example “Felix”, his pet cat, “Felicity”, his new friend, “Fencing”, a sport the user enjoys, and “Odd Fellow”, the name of a music band. The user decides that this list is too long to search through to find the content item which he wants to insert in his message.

In FIG. 5b, the user continues to compose his message 512 and so far has entered the character string “Feli . . . ”. The list of identified content items having metadata matching the character string “Feli . . . ” has been reduced to 26 items as shown by the “26 matches” display 516. This list of content items having matching metadata may include, for example, “Felix”, and “Felicity”, but will no longer include “Fencing” or “Odd Fellow” since these metadata labels do not include the string “Feli . . . ”. The user decides a list of 26 items is still too large to look through to find a content item to include, and so continues to enter his message.

In FIG. 5c, the user continues to compose his message 518 and enters the word “Felicity”. The apparatus has identified five content items having a metadata label matching the word “Felicity”. The apparatus in this example is configured to show a thumbnail or representative icon for selection when the list of content items found to have metadata matching the word being entered in the message is below a predetermined threshold, which is 10 items in this example (but may be different in other examples). Therefore the user is presented with a scrollable preview menu 528 (a pick-list) displaying content items 522, 524, 526 which, in this example, are photographs of his friend Felicity. The keyboard is still visible and in the foreground. In other example, the pick-list may not be scrollable. The apparatus again provides one or more content items 522, 524, 526 having matching metadata for insertion or attachment to the message 518, but the user need only make one selection to choose an item of interest for inclusion with the message 518 based on the displayed thumbnail image 522, 524, 526 in the pick-list. In other examples the user may be able to mark multiple items presented for inclusion through selection of multiple content items, and the multiple items can be inserted in, or attached to, the message being composed.

The user decides that he has seen a nice photograph of Felicity to include in his MMS message 530, so he selects the photograph thumbnail 526 (for example, by touching it on the displayed pick-list). The apparatus then automatically inserts this image 534 into the body of the MMS message 530 and automatically allows for continued message entry so that the user can then continue to compose his message 532 by writing “I met her in . . . ”. If the user does not select a thumbnail but enters a key on the visible virtual keyboard in the foreground of the display, message composition may continue, and the content items provided for selection may be removed from view. The list of content items may remain available for the duration of the message composition or for a predetermined time in case the user wishes to select one of the content items after entering further text.

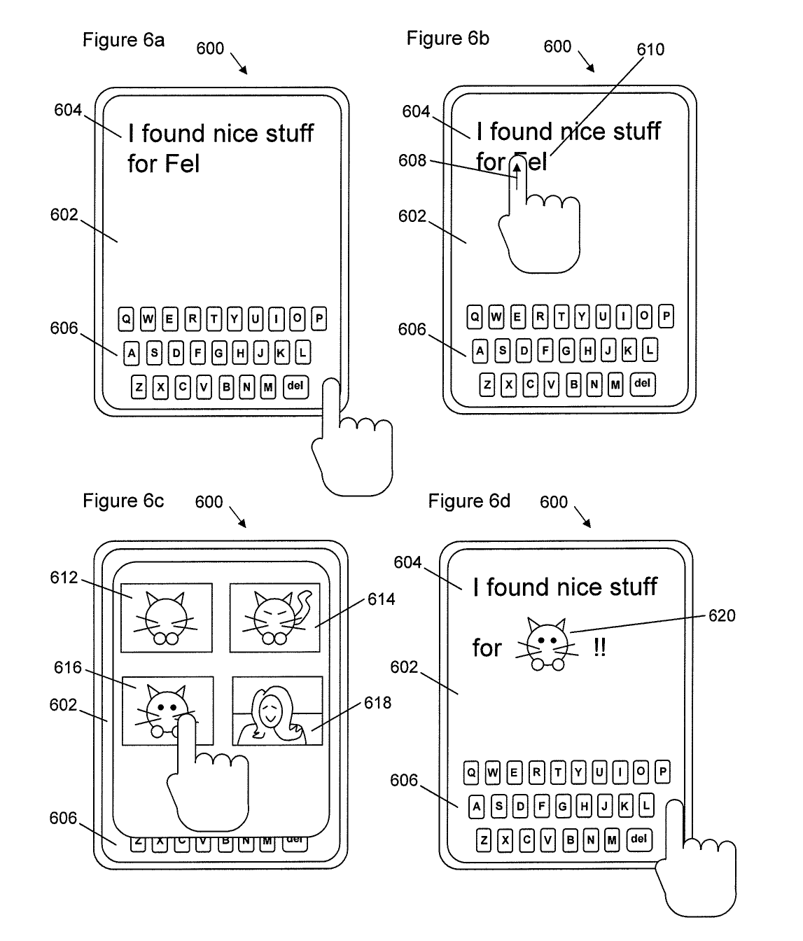

FIGS. 6a-6d illustrate an example of the apparatus/device 600 in use. A user is composing an e-mail message using a tablet computer 600 with a touch-sensitive display screen 602. The display 602 is displaying a message 604 and a virtual keyboard 606. The message being composed 604 is shown at the top of the display 604 while the virtual keyboard 606 is at the bottom of the same display. The user in this example is writing an e-mail to a friend to say they found a great toy for his cat Felix.

In FIG. 6a, the user has partially entered a message 604 which reads “I found nice stuff for Fel . . . ”. The word “Felix” has only partially been entered. The apparatus is configured to use the keyboard entered characters forming part of the message 640, in this case “Fel . . . ”, to search for one or more content items having metadata matching the one or more entered characters.

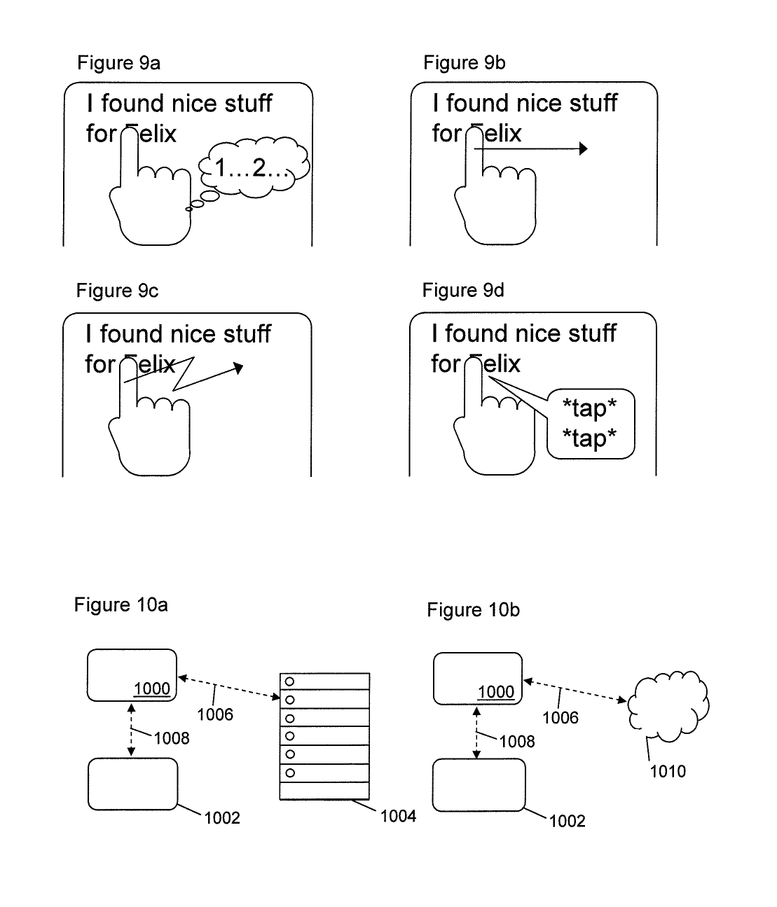

The user decides part way through entering the word “Felix” that they would like to include a photograph of Felix the cat. FIG. 6b shows the user making a specific user search indication 608 associated with the displayed entered characters “Fel . . . ” 610 which form part of the message. The specific user indication may be any suitable input relating to the displayed entered characters, as discussed further in relation to FIGS. 9a-9d.

In FIG. 6c, the apparatus provides a pick-list of four content items 612, 614, 616, 618 in an image preview menu/pick-list 610, which obscures the virtual keyboard (i.e., the virtual keyboard is in the background). The content items 612, 614, 616, 618 have metadata which matches the displayed characters which the user made a specific user search indication 608 on. The content items 612, 614, 616, 618 may be inserted in or attached to the message 604. In this example three photographs of Felix 612, 614, 616 and one photograph of the user's friend Felicity 618 are displayed. The photos 612, 614, 616 have the metadata “Felix”, and the photograph of Felicity has the metadata “Felicity”. Both these metadata labels include the characters “Fel . . . ” which were entered in the message 604. The user can make one or more selections from the preview menu 610 to choose an item of interest for inclusion with the message 604 based on the displayed thumbnail images 612, 614, 616, 618.

In FIG. 6d, the user has selected a photograph of Felix 620 (corresponding to a displayed thumbnail image 616) for insertion in the message 604. In this example, the apparatus is configured such that the one or more entered characters, “Fel . . . ”, forming part of the message 604 are replaced in the composed message with the selected content item 620 which has matching metadata, “Felix”. The user can then continue to compose his message.

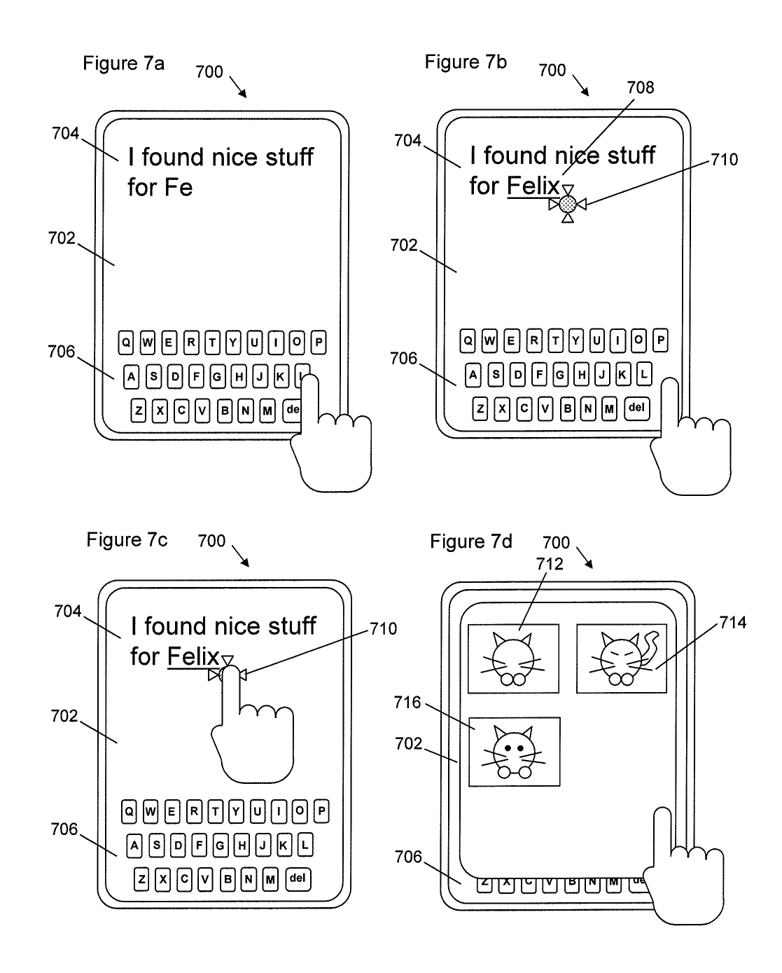

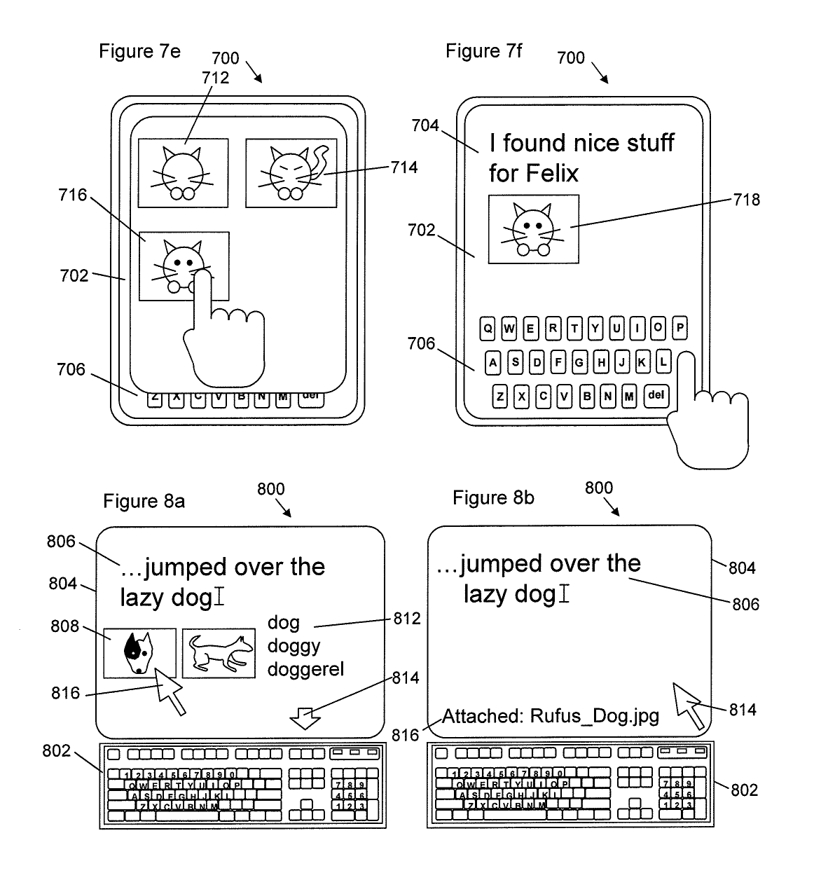

FIGS. 7a-7f illustrate an example of the apparatus/device in use. A user is composing a message using a smartphone 700 with a touch sensitive display 702. The display 702 is displaying a message 704 and a virtual keyboard 706. The user in this example is composing a message to another person about his cat, Felix.

In FIG. 7a, the user has partially entered the message 704 “I found nice stuff for Fel . . . ”. The word “Felix” has only partially been entered at this stage. In the example, the apparatus is configured to perform a matching metadata search upon the completion of entry of a full word or full expression.

In FIG. 7b, the user has completed the full word “Felix” 708, as indicated in this example by a pause of a predetermined length (for example, 2 seconds) after entry of the final character of the word. In other examples the end of a word or expression may be indicated by a specific key indication (such as the “enter” key), the entry of a character space, full stop, or more generally one or more punctuation marks, such as an exclamation mark, “!”), or search key, for example.

The apparatus in this example is configured to perform a matching metadata search upon a specific user search indication associated with a displayed symbol indicating an identified match between part of the composed message and matching metadata. Therefore, upon the indication of the end of a word, “Felix” 708, a symbol 710 is displayed indicating that one or more content items have been identified which have the matching metadata “Felix”. The user then has the option of interacting with the displayed symbol 710 to find a content item for inclusion/attachment, or, if the user does not want to include any content items for that word, the user can ignore the symbol 710 and continue to type. If the user continues to type without interacting with the symbol 710, then the symbol may disappear, for example upon the user continuing to type or after a predetermined period.

In FIG. 7c, the user has interacted with the symbol 710 by touching it. In FIG. 7d, as a result of the user touching the symbol 710 the apparatus provides three content items 712, 714, 716 which the user may select for insertion in the message 704. Each of the content items displayed has the metadata “Felix” which matches the word “Felix” entered in the body of the message 704. In FIG. 7e, the user selects one of the photographs 716 to include in the message 704. FIG. 7f shows that the selected photograph 718 has been included.

In the examples of FIGS. 5a-5d and 7a-7f, the apparatus is configured such that the one or more content items having matching metadata are inserted adjacent the one or more entered characters used to search.

FIGS. 8a and 8b illustrate an example of an apparatus in use. A user is composing a message using a desktop computer 800 with a physical keyboard 802 and display monitor 804. The user can interact with displayed elements using a pointer 816. The user is composing a message 808 “ . . . jumped over the lazy dog”.

In this example, the apparatus has performed a matching metadata search for any content item having the metadata “dog”. Therefore two photographs 808, 810 with the metadata “dog” are displayed. Also displayed are words 812 which have been determined to provide possible matches for the last word or partial word entered in the message 806, using predictive-text functionality. Thus the words 812 “dog, doggy, doggerel” are displayed as possible words which the user may be trying to input as judged from his entry of the characters “dog” at the end of the message 808.

In this example, the apparatus is configured to perform a metadata match between entered characters in the message 806 and content items having metadata corresponding to the entered characters, and display any matching entries alongside a predictive-text display 812 of possible matching words.

In FIG. 8b, the user has selected a photograph 808 for attachment to the message 806. Therefore the attachment is displayed as a note 816 at the bottom of the display 804. The user can continue to compose his message 806.

In the examples of FIGS. 5a-5d, 6a-6d, 7a-7f and 8a-8b, the user is able to compose a message and, part way through the message, insert a content item in the message without breaking the flow of typing, except to make a selection of the content item from an already searched preview menu/pick-list. Such a selection may be a tap or click on a thumbnail image or on a prompt that content items having matching metadata have been found. Advantageously, the user is not required to, for example:
click a particular “insert file” button,
manually search through a (potentially very large) file system to find a photograph which he wants to include,
remember the storage location, file name, storage data, or other information of a content item for inclusion,
perform any user inputs other than entering the message text except for one selection input of a content item presented as having matching metadata with text entered in the message,
be directed away from the message composition screen.

Therefore the user can advantageously compose a rich media message without breaking the flow of writing, and can receive prompts relevant to the size and content of relevant content items found for inclusion (such as a numerical indicator 510, 516 or a thumbnail image pick-list 528). In examples where the apparatus is configured to perform the search progressively as each character of a full word or full expression is progressively entered, the displayed pick-list of possible matching content items is updated dynamically as characters are entered/deleted. This can provide the user with a relevant, minimal, pick-list of possible content items for inclusion, further simplifying the media insertion/attachment process.

FIG. 9 illustrates different specific user search indications associated with displayed entered characters in the message, which may be made by a user during message composition using a keyboard. The search indication can initiate the apparatus to use the associated keyboard entered characters forming part of the message to search for one or more content items having metadata matching the one or more entered characters.

FIG. 9a shows a user performing a long press on part of the word “Felix”. A long press may have a duration of, for example, two seconds (but may be longer or shorter, and may be a user-defined duration). FIG. 9b shows a user performing a swipe across the word “Felix” from left to right. In other example, a swipe may be performed from right to left, up, down, or in any direction. FIG. 9c shows a user performing a zigzag gesture across the word “Felix”. FIG. 9d shows a user performing a “double-tap” gesture over the word “Felix”. The user search indication is used to cause the apparatus to search for content items having the metadata “Felix”. In other examples, such a user search indication may be performed over partial words, such as “Fel . . . ”. Other user gestures may also be suitable for use (for example, tracing a circle around the characters to match to content item metadata, underlining a series of characters/word to match to content item metadata, tracing a gesture associated with performing a metadata search (such as tracing an “M” for metadata over a touch-sensitive screen), or highlighting a particular entry e.g., using a mouse pointer).

Other specific user search indications may be performed to indicate that the user wishes any content items having metadata matching the indicated text to be searched for and provided. For example, a user may enter the text “Ted” to enter the text without any corresponding content item search, but may enter the text “@Ted”, “!Ted” or “#Ted”, for example, where the @, ! or # punctuation mark is a specific user search indication to the apparatus to search for content items having metadata matching the text associated with the punctuation mark, “Ted”. In other examples such a punctuation mark used to indicate a content item search is required may be placed at the end of the relevant text (whether a complete word or partial word e.g., “Ted#”), and may be any suitable punctuation mark or group of punctuation marks (e.g., “#Ted#” or “@@Ted”). A punctuation mark providing a specific user search indication may be user-configurable, so that the user may select a personally-preferred punctuation mark as a mark to be used to initiate a content item search. A user may select a preferred punctuation mark as being a mark which is easy and quick to input (for example, requiring only one key input rather than a combination or the use of a separate virtual keyboard) and which the user finds is distinguished from punctuation marks which are used in other contexts (for example, a user may not wish to use “#” as this may be used as a hashtag in other contexts). Another specific user search indication may be a pause of a predetermined length (e.g., three seconds) of time after entry of a character or group of characters intended for matching to metadata of one or more content items.

While the examples above relate to the composition of e-mail and MMS messages, a message may also be an electronic note, an electronic diary entry, a social media message, a website posting, a Facebook message, a Twitter message, or a message composed in a messaging application. Thus for example, a social media message or website posting may be readily composed which contains photographs, movies and audio files entered in the message via the selection from a pick-list of presented content items having matching metadata to one or more characters in the posting/message.

Further, in the above examples of FIGS. 5a-5d, 6a-6d and 7a-7f, a virtual keyboard remains on screen during the searching of metadata, and during the entry of the matching content items. This advantageously allows the user to concentrate on composing the text of their message, and since no laborious file or menu navigation is required to find and select a relevant content item for inclusion, the user is able to continue composing his message after content item insertion without losing his train of thought by being distracted by searching for a particular content item.

In certain examples, the searching may be turned off by a user if the searching is not required. Thus the apparatus may be configured to operate in a mode in which the searching is done, and another mode in which the searching is not done. It may be envisaged that the user is able to switch between the two modes in a simple way, for example by displaying a menu and checking or un-checking a “content item search” button.

It will be appreciated that embodiments of the present disclosure would be particularly useful in scenarios where quick/rapid message composition is required. Example scenarios include composition of a message of short length, such as one, two or three MMS message lengths, the length of a Twitter posting/tweet, or a message which is intended for real-time posting (e.g., a Facebook or Twitter message) which would take up to about five minutes to compose. Thus, convenience when preparing short/quick message composition is provided by embodiments of the present disclosure. It may not be so advantageous for situations where word processing/spreadsheet applications are being used; such applications may not be considered to be message composition applications as they would normally be used to provide lengthy developed content.

FIG. 10a illustrates an example embodiment of an apparatus according to the present disclosure in communication with a remote server. FIG. 10b shows that an example embodiment of an apparatus according to the present disclosure in communication with a “cloud” for cloud computing. In FIGS. 10a and 10b, an apparatus 1000 (which may be the apparatus 100, 200, 300, or an electronic device, 500, 600, 700, which is, or comprises, the apparatus) is in communication 1008 with, or may be in communication 1008 with, another device 1002. For example, an apparatus 1000 may be communication with another element of an electronic device such as a display screen, memory, processor, keyboard, mouse or a touch-screen input panel. The apparatus 1000 is also in communication with 1006 a remote computing element 1004, 1010.

FIG. 10a shows the remote computing element to be a remote server 1004, with which the apparatus may be in wired or wireless communication (e.g., via the internet, Bluetooth, a USB connection, or any other suitable connection). In FIG. 10b, the apparatus 1000 is in communication with a remote cloud 1010 (which may, for example, by the Internet, or a system of remote computers configured for cloud computing).

The apparatus 1000 may be able to obtain/download software or an application from a remote server 1004 or cloud 1010 to allow the apparatus 1000 to perform as described in the examples above. The metadata database shown in FIG. 4 may be a remote database stored on a server 1004 or cloud 1010 and accessible by the apparatus 1000.

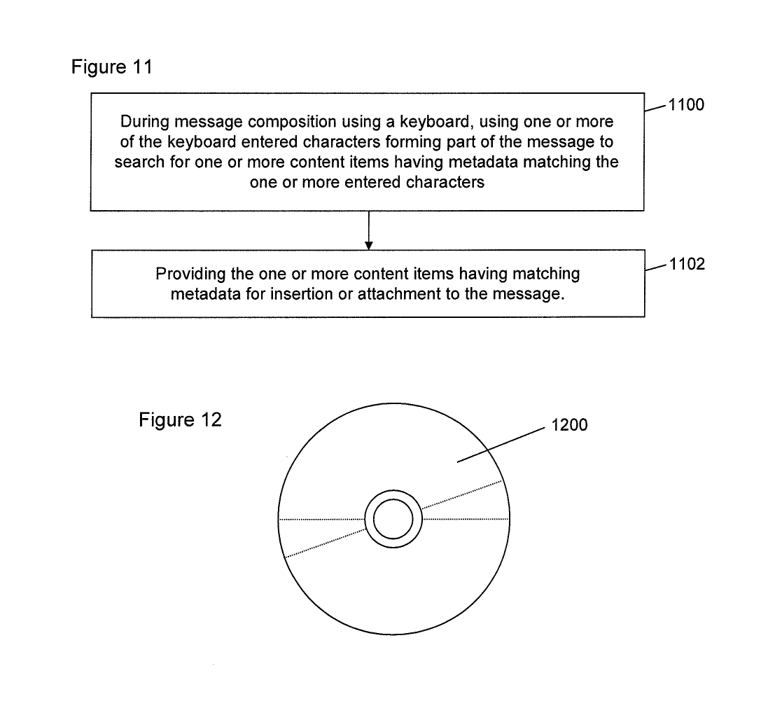

FIG. 11 shows a flow diagram illustrating the steps of, during message composition using a keyboard, using one or more of the keyboard entered characters forming part of the message to search for one or more content items having metadata matching the one or more entered characters 1100, and providing the one or more content items having matching metadata for insertion or attachment to the message 1102.

FIG. 12 illustrates schematically a computer/processor readable medium 1200 providing a program according to an example. In this example, the computer/processor readable medium is a disc such as a digital versatile disc (DVD) or a compact disc (CD). In other examples, the computer readable medium may be any medium that has been programmed in such a way as to carry out an inventive function. The computer program code may be distributed between the multiple memories of the same type, or multiple memories of a different type, such as ROM, RAM, flash, hard disk, solid state, etc.

Any mentioned apparatus/device/server and/or other features of particular mentioned apparatus/device/server may be provided by apparatus arranged such that they become configured to carry out the desired operations only when enabled, e.g., switched on. In such cases, the apparatus/device may not necessarily have the appropriate software loaded into the active memory in the non-enabled state (for example, a switched off state) and may only load the appropriate software in the enabled state (for example, an “on” state). The apparatus may comprise hardware circuitry and/or firmware. The apparatus may comprise software loaded onto memory. Such software/computer programs may be recorded on the same memory/processor/functional units and/or on one or more memories/processors/functional units.

In some examples, a particular mentioned apparatus/device/server may be pre-programmed with the appropriate software to carry out desired operations, wherein the appropriate software can be enabled for use by a user downloading a “key”, for example, to unlock/enable the software and its associated functionality. Advantages associated with such examples can include a reduced requirement to download data when further functionality is required for a device, can be useful in examples where a device is perceived to have sufficient capacity to store such pre-programmed software for functionality that may not be enabled by a user.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (such as, memory or a signal).

Any “computer” described herein can comprise a collection of one or more individual processors/processing elements that may or may not be located on the same circuit board, or the same region/position of a circuit board or even the same device. In some examples one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one or more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (such as ROM, or CD-ROM), these may comprise a computer processor, application specific integrated circuit (ASIC), field-programmable gate array (FPGA), and/or other hardware components that have been programmed in such a way to carry out the inventive function(s).

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/examples may consist of any such individual feature or combination of features. In view of the foregoing description it will be evident to a person skilled in the art that various modifications may be made within the scope of the disclosure.

While there have been shown and described and pointed out fundamental novel features as applied to examples thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures, elements and/or method steps shown and/or described in connection with any disclosed form or examples may be incorporated in any other disclosed or described or suggested form or example as a general matter of design choice. Furthermore means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
during message composition using a keyboard, use one or more of the keyboard entered characters forming part of the message to search for one or more content items having metadata matching the one or more entered characters; and
provide the one or more content items having matching metadata for insertion or attachment to the message.

2. An apparatus according to claim 1, wherein the keyboard is a virtual keyboard or a physical keyboard.

3. An apparatus according to claim 1, wherein the message is a multimedia service message, e-mail message, an electronic note, an electronic diary entry, a social media message, a website posting, a Facebook message, a Twitter message, or a message composed in a messaging application.

4. An apparatus according to claim 1, wherein the apparatus is configured to perform the search progressively as each character of a full word or full expression is progressively entered.

5. An apparatus according to claim 1, wherein the apparatus is configured to perform the search upon the completion of entry of a full word or full expression.

6. An apparatus according to claim 1, wherein the apparatus is configured to perform the search using a combination of two or more full words or full expressions which are entered.

7. An apparatus according to claim 1, wherein the apparatus is configured such that the one or more entered characters forming part of the message are retained in the composed message.

8. An apparatus according to claim 1, wherein the apparatus is configured such that the one or more content items having matching metadata are inserted adjacent the one or more entered characters used to search.

9. An apparatus according to claim 1, wherein the apparatus is configured such that the one or more entered characters forming part of the message are replaced with the one or more content items having matching metadata in the composed message.

10. An apparatus according to claim 1, wherein:
the apparatus is configured such that the one or more entered characters forming part of the message are searched against a categorisation aspect of the metadata; and
one or more content items having a matching categorisation, as indicated by the entered characters, are provided for insertion or attachment to the message.

11. An apparatus according to claim 10, wherein the categorisation is one or more of Image, Video, Music, Contact, Document and Other categorisation of content items.

12. An apparatus according to claim 1, wherein the metadata of a content item comprises: a user-assigned label for the content item; an automatically-assigned label for the content item; an auto-recognition text label for the content item; at least part of a file name of the content item; a storage location of the content item; or text within the content item.

13. An apparatus according to claim 1, wherein the apparatus is configured to perform the search upon a specific user search indication associated with at least one of:
a single key of the keyboard used to enter a character completing a part of the message;
a displayed symbol indicating an identified match between part of the composed message and matching metadata; and
a display of the entered characters forming a part of the message.

14. An apparatus according to claim 1, wherein the apparatus is configured such that the keyboard entered characters forming part of the message are shown as characters on a display.

15. An apparatus according to claim 1, wherein the keyboard is a virtual keyboard and the apparatus is configured such that the keyboard entered characters forming part of the message are shown as characters on a display at the same time as display of the virtual keyboard.

16. An apparatus according to claim 15, wherein the apparatus is configured such that the keyboard entered characters are shown as characters in a message output part of the display, and the virtual keyboard is shown in a message input part of the same display.

17. An apparatus according to claim 1, wherein the apparatus is configured to provide a plurality of content items having matching metadata for user selection in a pick-list prior to insertion or attachment of a content item to the composed message.

18. An apparatus according to claim 1, wherein the keyboard is a virtual keyboard and the apparatus is configured to retain the virtual keyboard on screen during the searching of metadata and/or during the entry of the one or more matching content items into the composed message.

19. A computer readable medium comprising computer program code stored thereon, the computer readable medium and computer program code being configured to, when run on at least one processor, perform at least the following:
during message composition using a keyboard, use one or more of the keyboard entered characters forming part of the message to search for one or more content items having metadata matching the one or more entered characters; and
provide the one or more content items having matching metadata for insertion or attachment to the message.

20. A method comprising:
during message composition using a keyboard, using one or more of the keyboard entered characters forming part of the message to search for one or more content items having metadata matching the one or more entered characters; and
providing the one or more content items having matching metadata for insertion or attachment to the message.
